(19) United States
(12) Patent Application Publication
(10) Pub. No.: US 2025/0381979 A1
(43) Pub. Date: Dec. 18, 2025

(54) SYSTEMS AND METHODS FOR DYNAMIC STEERING OF VEHICLE WHEELS TO FOLLOW DRIVING PATH

(71) Applicant: Toyota Research Institute, Inc., Los Altos, CA (US)

(72) Inventors: ANDREA MICHELLE RIOS LAZCANO, Brussels (BE); Hiroshi Yasuda, San Carlos, CA (US)

(73) Assignees: Toyota Research Institute, Inc., Los Altos, CA (US); Toyota Jidosha Kabushiki Kaisha, Toyota-shi (JP)

(21) Appl. No.: 18/742,459

(22) Filed: Jun. 13, 2024

(51) Int. Cl. B60W 60/00

(52) U.S. Cl. CPC B60W 60/001; B60W 2552/20; B60W 2720/24; B60W 2720/30

(57) ABSTRACT

In some implementations, a control system and method may include evaluating, based on sensor data, current operational parameters of the vehicle to determine a trajectory of the vehicle. In addition, the control system and method may include comparing the determined vehicle trajectory to a desired path for the vehicle through a segment of a route. The control system and method may include determining at least one control input to individually control one or more wheels of the vehicle to adjust the vehicle trajectory to assist the vehicle in following the desired path based on the comparing. Moreover, the control system and method may include sending a signal having one or more of the determined control inputs to one or more vehicle actuators to individually control a torque factor at one or more of the vehicle's drive wheels in accordance with the one or more control inputs.

### TECHNICAL FIELD

The present disclosure relates generally to vehicular control mechanisms, and in particular, some implementations may relate to controlling wheel parameters individually to achieve a preplanned trajectory.

### DESCRIPTION OF RELATED ART

Torque vectoring technology has been used in vehicle control systems to enhance handling, stability, and performance by precisely distributing torque to individual wheels. This technique allows for greater handling and stability, particularly during challenging driving conditions. Braking forces and motive forces can be applied to the wheels individually to help control a vehicle's attitude. Torque vectoring may be based on factors such as vehicle speed, steering angle, throttle input, and road conditions.

By selectively applying an amount of torque to specific wheels, the system can influence the vehicle's yaw rate (rotation around its vertical axis), helping it to turn more efficiently and with greater stability. For example, during cornering, torque vectoring can send more power to the outer wheels while reducing power to the inner wheels to help counteract understeer or oversteer. By actively managing torque distribution, torque vectoring systems can help maintain stability and control in various driving conditions, including driving on slippery surfaces or during sudden maneuvers.

Individual wheel steering is another technology aimed at enhancing vehicle maneuverability, stability, and safety. Unlike traditional steering systems where the front wheels turn together and the rear wheels do not steer, individual wheel steering allows each wheel to steer independently of the others based on various driving conditions and input from the driver. Traditional systems typically engage rear-wheel steering during certain driving conditions. For example, the system can be engaged based on the speed of the vehicle. During low-speed driving, the rear wheels may turn in the opposite direction as the front wheels to decrease the turning radius and enhance maneuverability in tight spaces. At high speeds, the rear wheels may turn in the same direction as the front wheels, improving stability and enhancing lane changes and high-speed handling. Control is typically based on various factors such as vehicle speed, steering input, road conditions, and driving mode.

### BRIEF SUMMARY OF THE DISCLOSURE

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include evaluating, based on sensor data, current operational parameters of the vehicle to determine a trajectory of the vehicle. The method may also include comparing the determined vehicle trajectory to a desired path for the vehicle through a segment of a route. The method may furthermore include determining at least one control input to individually control one or more wheels of the vehicle to adjust the vehicle trajectory to assist the vehicle in following the desired path based on the comparing. The method may in addition include sending a signal may include one or more of the determined at least one control input to one or more vehicle actuators to individually control a torque factor at one or more of the vehicle's drive wheels in accordance with the control inputs. Other embodiments of this aspect include corresponding computer systems, apparatus, and computer programs recorded on one or more computer storage devices, each configured to perform the actions of the methods.

Implementations may include one or more of the following features. The method where individually controlling a torque factor at one or more of each of the vehicle's drive wheels may include controlling a torque factor of at least one drive wheel of the vehicle differently from the other drive wheels of the vehicle. The method where individually controlling a torque factor at one or more of each of the vehicle's drive wheels may include controlling a torque factor of a set of two or more drive wheels of the vehicle differently from the other drive wheels of the vehicle. The method where the torque factor may include one or more of acceleration torque, braking torque, friction braking and steering input. The method where the desired path may include a path through a segment of road identified to improve a driving objective. The method where the driving objective may include at least one of vehicle speed, economy of vehicle operation or vehicle occupant comfort. The method where the desired path may include a race line of a segment of a racetrack. The method may further include determining the desired path for the vehicle to follow through a first segment of a route. The method where the desired path is determined based on one or more of driver history, crowdsourced history, or user-entered data. The method where assisting the vehicle in following the desired path may include at least one of assuming full autonomous control of the vehicle or providing the at least one control input as partial control of the vehicle to supplement driver control. Implementations of the described techniques may include hardware, a method or process, or a computer tangible medium.

In one general aspect, a vehicle control system may include one or more processors. The vehicle control system may also include a memory coupled to the processor to store instructions, which when executed by the processor, cause the processor to perform operations, the operations may include: the system determining a desired path for the vehicle to follow through a first segment of a route. The system may in addition include evaluating, based on sensor data, current operational parameters of the vehicle to determine a trajectory of the vehicle. The system may moreover include comparing the determined vehicle trajectory to the desired path. The system may also include determining at least one control input to individually control one or more wheels of the vehicle to adjust the vehicle trajectory to assist the vehicle in following the desired path based on the comparing. The system may furthermore include sending a signal may include one or more of the determined at least one control input to one or more vehicle actuators to individually control a torque factor at one or more of the vehicle's wheels in accordance with the control inputs. Other embodiments of this aspect include corresponding computer systems, apparatus, and computer programs recorded on one or more computer storage devices, each configured to perform the actions of the methods.

Implementations may include one or more of the following features. The system individually controlling a torque factor at one or more of each of the vehicle's wheels may include controlling a torque factor of at least one drive wheel of the vehicle differently from the other wheels of the vehicle. The vehicle control system where individually controlling a torque factor at one or more of each of the vehicle's wheels may include controlling a torque factor of a set of two or more drive wheels of the vehicle differently from the other wheels of the vehicle. The vehicle control system where the torque factor may include one or more of acceleration torque, braking torque, friction braking and steering input. The vehicle control system where the desired path may include a path through a segment of road identified to improve a driving objective. The vehicle control system where the driving objective may include at least one of vehicle speed, economy of vehicle operation or vehicle occupant comfort. The vehicle control system where the desired path may include a race line of a segment of a racetrack. The vehicle control system may further include determining the desired path for the vehicle to follow through a first segment of a route. The vehicle control system where the desired path is determined based on one or more of driver history, crowdsourced history, or user-entered data. The vehicle control system where assisting the vehicle in following the desired path may include at least one of assuming full autonomous control of the vehicle or providing the at least one control input as partial control of the vehicle to supplement driver control. Implementations of the described techniques may include hardware, a method or process, or a computer tangible medium.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates examples of a racing line through different example corners of a track.

FIG. 2 is an operational flow diagram illustrating an example process for independently controlling wheels of the vehicle with the objective being to cause the vehicle trajectory to follow a desired path in accordance with various embodiments.

FIG. 3 is a diagram illustrating an example control system in accordance with various embodiments.

FIG. 4 is a diagram illustrating an example control system in accordance with various embodiments.

The figures are not exhaustive and do not limit the present disclosure to the precise form disclosed.

### DETAILED DESCRIPTION

Embodiments of the systems and methods disclosed herein can provide systems and methods for individually actuating control parameters for one or more wheels of a vehicle to assist the vehicle to maintain vehicle trajectory on a desired line along a vehicle path, such as a racing line on a segment of a racetrack. Embodiments disclosed herein may be implemented to control the vehicle (e.g., ranging from full autonomous control or augmenting diver control at lower levels of autonomy) to maintain or attempt to maintain a chosen line for the vehicle.

Systems and methods for dynamically adjusting torque factors of individual wheels of an over-actuated vehicle are disclosed. In one approach, the system is utilized in a racing vehicle to allow a vehicle to follow the ideal racing line. The system may identify/calculate the ideal racing line of a track based on the known geometry of the track and/or based on real-time perception. Implementations may adjust steering of the vehicle tires according to whether the vehicle is driving straight or taking a turn. When driving straight, the system may only allow the front tires to steer/constrain how much they can steer. On the other hand, when the system identifies that the vehicle is approaching a curve, the system allows the vehicle to use all of the tires to steer. In this way, the steering of each tire is optimized for following the ideal racing line. In addition to automatically adjusting the steering of the individual vehicle tires, a user may enter inputs within the vehicle to manually adjust which tires are steering at any given moment. Other torque factors may also be adjusted, including acceleration torque, braking torque and friction braking.

The racing line for a circuit—e.g., a racetrack or a segment thereof—is typically the optimal path that a driver takes around the circuit to complete a lap (or segment) in the fastest possible time. In ideal conditions, the line might be a fixed line around the track that not only optimizes lap time or speed around the track, but may alternatively achieve other desired goals such as conservation of tires or fuel, or the line may be chosen to balance a combination of goals. The line through a corner is often determined as a line that hits the apex so as to allow more immediate and greater acceleration out of the corner. The goal for most corners is to increase the effective radius of the turn or to maximize acceleration out of the corner and into the straight section to achieve maximum speed. The line may also consider sacrifice corners, in which speed is sacrificed in a first portion of a compound corner to achieve better placement and greater acceleration out of the second portion of the corner.

The apex may be identified as the point of minimum radius on the line through the corner and is therefore usually the point of slowest speed achieved in a corner. The position of the apex, and of the line overall, may vary based on a vehicle's availabilities. It may also vary based on other factors like the presence of other vehicles, driver intentions, racetrack layout and so on. For example, a late apex might be chosen on hairpin turns or on corners that precede a long straight stretch. The late apex may increase the length of the straight stretch that follows the curve. This line typically employs hard, late braking to hit an apex toward the exit of the curve. Early apexes aren't used very often, but might be chosen, for example, for a sacrifice corner to achieve the proper setup for the succeeding corner. The early apex requires earlier braking and turn in.

As the foregoing indicates, the line isn't the same through each corner, and instead is a trajectory that varies depending on factors such as the layout of the track, the presence of other drivers, the type of corner, the driver's intentions, and so on. The ideal line may also vary based on the characteristics of the vehicle, and the conditions of the race.

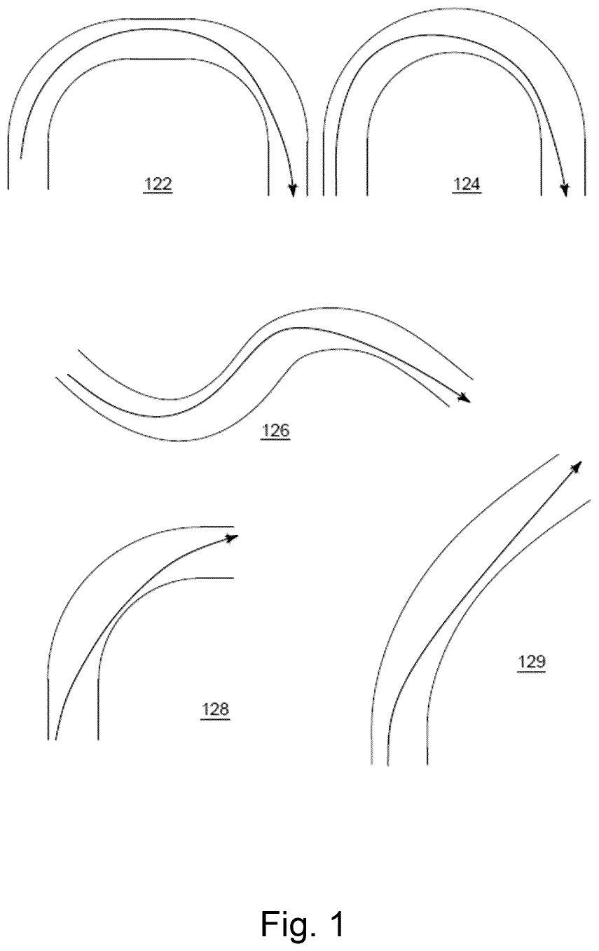

FIG. 1 illustrates examples of a racing line through different corners of a track. These are only examples, and other lines on segments such as these, or on other segments, may be chosen based on a number of factors. Referring now to FIG. 1, 122 illustrates a pair of 90° right-hand turns and an example racing line Through the turns. In this example there is a later turn-in for the 1st right-hand turn and an earlier turn in for the second right-hand turn. The example at 124 illustrates a constant-radius hairpin turn of a given radius. The example at 126 illustrates an S style turn made-up of a left-hand turn followed by a right-hand turn and an example racing line through the curve. This is an example where the first part of the curve, the left-hand turn, may be a sacrifice turn. The example at 128 illustrates a 90° right hand constant-radius turn followed by a straight section. The racing line here maximizes the radius through the turn, hitting the apex at the center of the turn. Compare the line through section 128 with the line through the 1st right-hand turn of section 122. The line through the first right-hand turn in section 122 in this example is chosen to allow the vehicle to be in a proper position for the second right-hand turn of that section. In comparison, the line in the example that 128 is chosen to maximize speed through and out of the curve. The example that 129 illustrates any sample of a line through a decreasing-radius corner. These examples are shown merely to provide background information for possible racing lines through the segments of a racetrack. The technology disclosed herein is not limited to application with these examples but may be applied to have a number of different determined paths for the vehicle.

Embodiments disclosed herein may be implemented to control the vehicle (e.g., autonomous control or augmenting diver control at lower levels of autonomy) to maintain or attempt to maintain the chosen line for the vehicle. In one general aspect, a vehicle control system may include one or more processors and memory coupled to the one or more processors to store instructions, which when executed by the one or more processors, cause the one or more processors to perform operations for vehicle control. The operations may include determining a desired path for the vehicle to follow through a first segment of a route; evaluating, based on sensor data, current operational parameters of the vehicle to determine a trajectory of the vehicle; comparing the determined vehicle trajectory to the desired path; determining at least one control input to individually control one or more wheels of the vehicle to adjust the vehicle trajectory to follow the desired path based on the comparing; and sending a signal having one or more of the determined control inputs to one or more vehicle actuators to individually control a torque factor at one or more of each of the vehicle's wheels in accordance with the control inputs.

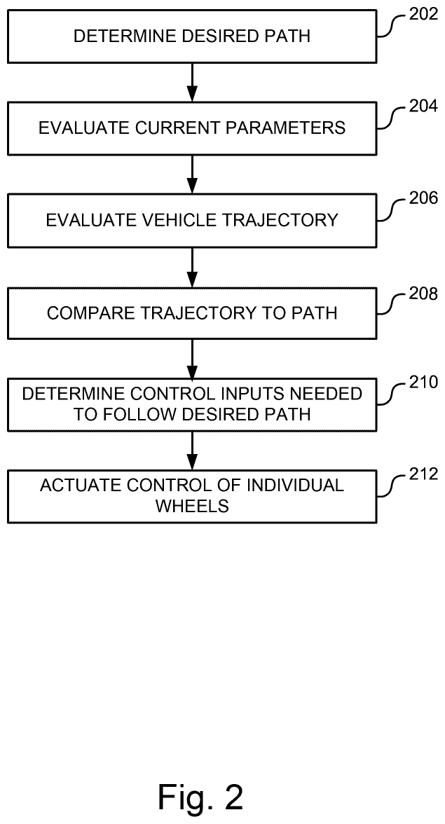

FIG. 2 is an operational flow diagram illustrating an example process for independently controlling wheels of the vehicle with the objective being to cause the vehicle trajectory to follow a desired path in accordance with various embodiments.

At operation 202, the example systems and methods determine a desired path for the vehicle to follow through a first segment of a route. The segment of the route may be, for example, any kind of road or racetrack or other vehicle route, or a portion thereof that includes one or more corners. In one embodiment, the desired path is a desired racing line through the route segment.

The path can be determined in a number of different ways. For example, the data can be collected as driver history such as from previous trips of the current driver through the segments of interest. As another example, the path can be determined using crowdsourced data—e.g., or from one or more of a plurality of drivers traversing the segments of interest indicating a preferred path used by those one or more drivers through those segments. Historic information can Gathered from real world driving experiences, or it can be gathered using simulator data from simulated driving experience across the relevant segment or segments.

A desired path might be the average of one or more of the paths followed by the one or more of a plurality of other drivers, and it may include several passes by an involved driver or drivers. The desired path might be determined by calculating which path or paths in the data set yielded the best results in those driving scenarios. This could be the path or paths in the data set that yielded the best lap times, the fastest speed through a corner, the fastest exit speed, the best fuel economy, the least vehicle wear, or a combination of the foregoing.

In other examples, the path can be determined through other means, such as by a user and in which the chosen path can be input by the user into the vehicle system via a user interface. Again, the path chosen may be the path intended to yield the best lap times, the fastest speed through a corner, the fastest exit speed, the best fuel economy, the least vehicle wear, or a combination of the foregoing.

Implementations may also choose a path in a manner that is vehicle dependent. For example, different vehicles may have different paths through the segment, depending on the goals of the path (e.g., fastest speed, best economy, etc.). Accordingly, for determinations based on crowd-sourced or historic path data, the data set can be filtered by vehicle. This could be, for example, by make, model or trim, or may be by vehicle class type (large SUV>5,000 lbs. GVW, RWD sports car, FWD van, etc.). The filtering may also consider vehicle modifications and options on the vehicle (e.g., wheels, tires, suspension, transmission, power, gear ratio, etc.).

The data set might also be filtered based on external factors such as weather data and environment (different paths for different traction levels based on weather conditions or environment).

The path may be adjusted based on a variety of factors such as driver objectives (e.g., speed, conservation, safety), identified road hazards to avoid or consider (e.g., object in road, oil slick that affects traction, accident in the segment, etc.) and other factors that might affect choice of a path through the segment.

At operation 204 the control system evaluates current parameters that affect the vehicle's trajectory or ability to follow the identified path. For example, the control system may receive sensor data or processed data that can be used to determine vehicle speed, vehicle attitude, front-rear loading, slippage, and so on. The system may also use data to determine a vehicle performance envelope or performance capabilities. For example, the system may evaluate vehicle setup (e.g., specifications for brakes, suspension, tires, etc.), vehicle condition (e.g., brake temperature/fade, weight balance and loading, tire tread, etc.), environmental conditions (e.g., weather, road surface, etc.) and other parameters that may affect a vehicles ability to follow a line at a certain speed, acceleration and braking levels.

The system may also be configured to receive information to determine driver input. This may include input as the driver navigates the vehicle toward and through the segment. This can include information such as steering input, braking, and acceleration. The system may also determine current vehicle parameters such as attitude and acceleration (e.g., acceleration in three dimensions) and roll, pitch and yaw.

At operation 206, the control system evaluates the vehicle's current trajectory. This step can be configured to look at the vehicle trajectory. For example, the system may determine the current path of the vehicle as it moves. This may include its position, speed and acceleration (which can include 3-dimensional acceleration data) over time. The trajectory may describe the relationship between the vehicle and the segment's (e.g., the road's or track's) geometry. The trajectory may indicate the path that the vehicle is currently following along the route, such as when it is approaching and as it enters a segment.

At operation 208, the control system compares the determined vehicle trajectory to the desired path. Where the trajectory deviates from the desired path (e.g., as determined at operation 202), this deviation may be noted and determined. The deviation may be determined based on a predicted inability of the vehicle to follow the desired path, which may be determined based on the current vehicle trajectory (e.g., as determined at operation 206) and current parameters (e.g., as determined at operation 204).

The deviation may also be determined based on a vehicle's current position and the amount that deviation varies from the desired path. The deviation may also be determined based on a combination of path deviation and inability to follow the desired path. Where the vehicle's current path deviates from the desired path, the control system may be configured to determine a new desired path from the vehicle's current point on the segment (e.g., using the same techniques described above reference to operation 202). A new path may consider the vehicle's current point as the starting point of the new path and the new path determined as a desired path through the segment from that new starting point.
1. Where the determined vehicle trajectory indicates that the vehicle will be unable to follow the desired path without assistance from the control system, the control system may determine inputs that may be used to enable the vehicle to more closely follow the desired path. Accordingly, at operation 210, the control system determines the control inputs needed to assist the vehicle in following the determined desired path. Assisting the vehicle in following the desired path in various implementations may range from assuming full autonomous control of the vehicle to providing the control inputs as partial control of the vehicle to supplement driver control.

In some applications, these control inputs may be control inputs used to control one or more wheels of the vehicle independently from the other wheels of the vehicle. In some instances, this control for each wheel can be different for each wheel or for groups of wheels (e.g., for the left or right wheels or for the front or rear wheels).

For example, applying a desired combination of one or more torque factors such as driving torque, braking torque, or no torque along with friction braking and steering inputs to each wheel individually can allow the system to generate a yaw moment to implement yaw control. The inputs may be provided in a nonlinear fashion to alter the dynamics of a cornering vehicle. in some implementations, this may be applied as a discontinuous control signal to alter vehicle dynamics and behavior.

For example, the system may be configured to actuate a controller to control one or more torque factors applied to the wheels. This may include, e.g., the application of braking forces, deceleration forces, acceleration forces or steering input to the wheels to affect vehicle attitude or trajectory to assist the driver in following the line. As noted, the desired levels of one or more of braking, acceleration and steering input can be applied to each wheel or set of wheels independently and the levels, or combination of levels, can be different for each wheel or set of wheels.

The application of torque that may be controlled individually for each wheel repeat from question number of different ways. For example, each wheel may be driven, at least in part, by an individual motor, and the motors can be controlled separately for each wheel. As another example, differentials can be used to control the amount of torque applied to each wheel. Hydraulics driven by a motorized pump may also be used to control the torque applied to each wheel. As yet another example, the braking forces applied to each wheel by the vehicle brakes may also be used to individually control the vehicle's wheels.

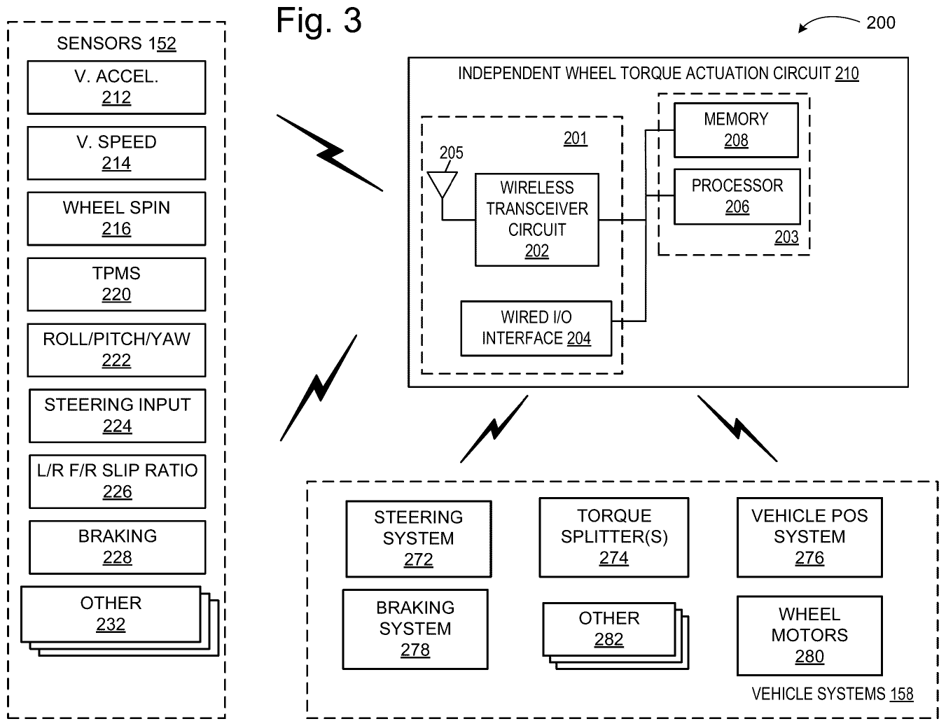

FIG. 3 is a diagram illustrating an example control system in accordance with various embodiments. This diagram illustrates an example architecture for implementing independent control (e.g., as described above with reference to FIG. 2) Referring now to FIG. 3, in this example, independent wheel torque actuation circuit 200 includes an independent wheel torque actuation circuit 210, a plurality of sensors 152 and a plurality of vehicle systems 158. Sensors 152 and vehicle systems 158 can communicate with independent wheel torque actuation circuit 210 via a wired or wireless communication interface. Although sensors 152 and vehicle systems 158 are depicted as communicating with independent wheel torque actuation circuit 210, they can also communicate with each other as well as with other vehicle systems. Independent wheel torque actuation circuit 210 can be implemented as an ECU or as part of an ECU. In other embodiments, independent wheel torque actuation circuit 210 can be implemented independently of the ECU.

Independent wheel torque actuation circuit 210 in this example includes a communication circuit 201, a decision circuit 203 (including a processor 206 and memory 208 in this example) and a power supply 212. Components of independent wheel torque actuation circuit 210 are illustrated as communicating with each other via a data bus, although other communication in interfaces can be included.

Processor 206 can include one or more GPUs, CPUs, microprocessors, or any other suitable processing system. Processor 206 may include one or more single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory, and may be configured to store data and other information as well as operational instructions that may be used by the processor 206 to independent wheel torque actuation circuit 210.

Although the example of FIG. 3 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a independent wheel torque actuation circuit 210.

Communication circuit 201 includes either or both a wireless transceiver circuit 202 with an associated antenna 214 and a wired I/O interface 204 with an associated hardwired data port (not illustrated). As this example illustrates, communications with independent wheel torque actuation circuit 210 can include either or both wired and wireless communications circuits 201. Wireless transceiver circuit 202 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by independent wheel torque actuation circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Sensors 152 can include, for example, sensors 52 such as those used to gather data described above with reference to the example of FIG. 2. Sensors 152 can include additional sensors that may or may not otherwise be included on a standard vehicle 10 with which the control system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, steering input sensors 224, left-right and front-rear slip ratio sensors 226, and braking sensors 228. Additional sensors 232 can also be included as may be appropriate for a given implementation of assist-mode system 200. for example, environmental sensors may be used to detect environmental conditions surrounding the vehicle which may be useful to determine segment surface conditions including traction.

Vehicle systems 158 can include any of a number of different vehicle components or subsystems used to control or monitor various aspects of the vehicle and its performance. In this example, the vehicle systems 158 include a GPS or other vehicle positioning system 276; torque splitters 274 that can control distribution of power among the vehicle wheels such as, for example, by controlling front/rear and left/right torque split; steering system 272 to control steering of the vehicle wheels (e.g, to control steering input of each wheel independent of the other wheels); wheel motors 280 such as, for example, to accelerate or decelerate (or keep neutral) each wheel.

During operation, independent wheel torque actuation circuit 210 can receive information from various vehicle sensors to determine what torque inputs should be applied to each of the wheels to assist keeping the vehicle on the desired path. Communication circuit 201 can be used to transmit and receive information between independent wheel torque actuation circuit 210 and sensors 152, and independent wheel torque actuation circuit 210 and vehicle systems 158. Also, sensors 152 may communicate with vehicle systems 158 directly or indirectly (e.g., via communication circuit 201 or otherwise).

In various embodiments, communication circuit 201 can be configured to receive data and other information from sensors 152 that is used in determining whether vehicle systems 158 should be actuated to control torque or steering of the vehicle wheels individually to assist the vehicle in following their desired line.

Communication circuit 201 can be used to send an activation signal or other activation information to various vehicle systems 158 as part of controlling the wheels of the vehicle. For example, communication circuit 201 can be used to send signals to one or more of: torque splitters 274 to control front/rear torque split or left/right torque split or both; motor controllers 280 to, for example, control motor torque, motor speed of the various motors in the system for each wheel; braking system 278 to, for example, control braking for each wheel; and steering system 272 two, for example, control a steering input at each wheel.

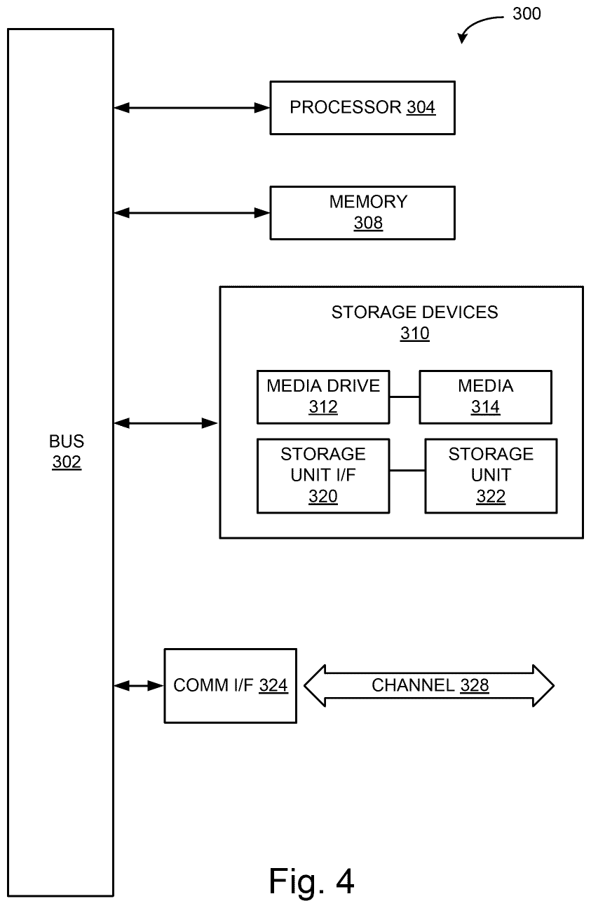

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 4. Various embodiments are described in terms of this example-computing component 300. After reading this description, it will become apparent to a person skilled in the relevant art how to implement the application using other computing components or architectures.

Referring now to FIG. 4, computing component 300 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 300 might also represent computing capabilities embedded within or otherwise available to a given device. For example, a computing component might be found in other electronic devices such as, for example, portable computing devices, and other electronic devices that might include some form of processing capability.

Computing component 300 might include, for example, one or more processors, controllers, control components, or other processing devices. Processor 304 might be implemented using a general-purpose or special-purpose processing engine such as, for example, a microprocessor, controller, or other control logic. Processor 304 may be connected to a bus 302. However, any communication medium can be used to facilitate interaction with other components of computing component 300 or to communicate externally.

Computing component 300 might also include one or more memory components, simply referred to herein as main memory 308. For example, random access memory (RAM) or other dynamic memory, might be used for storing information and instructions to be executed by processor 304. Main memory 308 might also be used for storing temporary variables or other intermediate information during execution of instructions to be executed by processor 304. Computing component 300 might likewise include a read only memory (“ROM”) or other static storage device coupled to bus 302 for storing static information and instructions for processor 304.

The computing component 300 might also include one or more various forms of information storage mechanism 310, which might include, for example, a media drive 312 and a storage unit interface 320. The media drive 312 might include a drive or other mechanism to support fixed or removable storage media 314. For example, a hard disk drive, a solid-state drive, a magnetic tape drive, an optical drive, a compact disc (CD) or digital video disc (DVD) drive (R or RW), or other removable or fixed media drive might be provided. Storage media 314 might include, for example, a hard disk, an integrated circuit assembly, magnetic tape, cartridge, optical disk, a CD or DVD. Storage media 314 may be any other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing component 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory component) and memory slot. Other examples may include a PCMCIA slot and card, and other fixed or removable storage units 322 and interfaces 320 that allow software and data to be transferred from storage unit 322 to computing component 300.

Computing component 300 might also include a communications interface 324. Communications interface 324 might be used to allow software and data to be transferred between computing component 300 and external devices. Examples of communications interface 324 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 324 may be carried on signals, which can be electronic, electromagnetic (which includes optical) or other signals capable of being exchanged by a given communications interface 324. These signals might be provided to communications interface 324 via a channel 328. Channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 308, storage unit 320, media 314, and channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 300 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of controlling a vehicle, the method comprising:
evaluating, based on sensor data, current operational parameters of the vehicle to determine a trajectory of the vehicle;
comparing the determined vehicle trajectory to a desired path for the vehicle through a segment of a route;
determining at least one control input to individually control one or more wheels of the vehicle to adjust the vehicle trajectory to assist the vehicle in following the desired path based on the comparing; and
sending a signal comprising one or more of the determined at least one control input to one or more vehicle actuators to individually control a torque factor at one or more of the vehicle's drive wheels in accordance with the control inputs.

2. The method of claim 1, wherein individually controlling a torque factor at one or more of each of the vehicle's drive wheels comprising controlling a torque factor of at least one drive wheel of the vehicle differently from the other drive wheels of the vehicle.

3. The method of claim 1, wherein individually controlling a torque factor at one or more of each of the vehicle's drive wheels comprising controlling a torque factor of a set of two or more drive wheels of the vehicle differently from the other drive wheels of the vehicle.

4. The method of claim 1, wherein the torque factor comprises one or more of acceleration torque, braking torque, friction braking and steering input.

5. The method of claim 1, wherein the desired path comprises a path through a segment of road identified to improve a driving objective.

6. The method of claim 5, wherein the driving objective comprises at least one of vehicle speed, economy of vehicle operation or vehicle occupant comfort.

7. The method of claim 5, wherein the desired path comprises a race line of a segment of a racetrack.

8. The method of claim 1, further comprising determining the desired path for the vehicle to follow through a first segment of a route.

9. The method of claim 8, wherein the desired path is determined based on one or more of driver history, crowdsourced history, or user-entered data.

10. The method of claim 1, wherein assisting the vehicle in following the desired path comprises at least one of assuming full autonomous control of the vehicle or providing the at least one control input as partial control of the vehicle to supplement driver control.

11. A vehicle control system, comprising:
one or more processors; and
a memory coupled to the processor to store instructions, which when executed by the processor, cause the processor to perform operations, the operations comprising:
determining a desired path for the vehicle to follow through a first segment of a route;
evaluating, based on sensor data, current operational parameters of the vehicle to determine a trajectory of the vehicle;
comparing the determined vehicle trajectory to the desired path;
determining at least one control input to individually control one or more wheels of the vehicle to adjust the vehicle trajectory to assist the vehicle in following the desired path based on the comparing; and
sending a signal comprising one or more of the determined at least one control input to one or more vehicle actuators to individually control a torque factor at one or more of the vehicle's wheels in accordance with the control inputs.

12. The vehicle control system of claim 11, wherein individually controlling a torque factor at one or more of each of the vehicle's wheels comprising controlling a torque factor of at least one drive wheel of the vehicle differently from the other wheels of the vehicle.

13. The vehicle control system of claim 11, wherein individually controlling a torque factor at one or more of each of the vehicle's wheels comprising controlling a torque factor of a set of two or more drive wheels of the vehicle differently from the other wheels of the vehicle.

14. The vehicle control system of claim 11, wherein the torque factor comprises one or more of acceleration torque, braking torque, friction braking and steering input.

15. The vehicle control system of claim 11, wherein the desired path comprises a path through a segment of road identified to improve a driving objective.

16. The vehicle control system of claim 15, wherein the driving objective comprises at least one of vehicle speed, economy of vehicle operation or vehicle occupant comfort.

17. The vehicle control system of claim 15, wherein the desired path comprises a race line of a segment of a racetrack.

18. The vehicle control system of claim 11, further comprising determining the desired path for the vehicle to follow through a first segment of a route.

19. The vehicle control system of claim 18, wherein the desired path is determined based on one or more of driver history, crowdsourced history, or user-entered data.

20. The vehicle control system of claim 11, wherein assisting the vehicle in following the desired path comprises at least one of assuming full autonomous control of the vehicle or providing the at least one control input as partial control of the vehicle to supplement driver control.
